(19) United States
(12) Patent Application Publication
(10) Pub. No.: US 2021/0107033 A1
(43) Pub. Date: Apr. 15, 2021

(54) Drilling System Including a Slurry Management System

(71) Applicant: Halliburton Energy Services, Inc., Houston, TX (US)

(72) Inventors: Andrew D. Vos, Spring, TX (US); Brice Aaron Jackson, Houston, TX (US); Lawrence Herskowitz, Pearland, TX (US); Daniel Reynold Robichaud, Humble, TX (US)

(73) Assignee: Halliburton Energy Services, Inc., Houston, TX (US)

(21) Appl. No.: 16/600,759

(22) Filed: Oct. 14, 2019

(51) Int. Cl. B07B 1/46; H04W 4/80; B07B 1/40; E21B 21/06

(52) U.S. Cl. CPC B07B 1/4672; E21B 21/065; B07B 1/40; H04W 4/80

(57) ABSTRACT

A slurry management system. The slurry management system may include a screen assembly and an RFID reader. The screen assembly may include a shaker screen and RFID tags arranged on the shaker screen. The RFID reader may be positioned to read locations of the RFID tags.

### BACKGROUND

This section is intended to provide relevant background information to facilitate a better understanding of the various aspects of the described embodiments. Accordingly, it should be understood that these statements are to be read in this light and not as admissions of prior art.

In drilling oil and gas wells, drilling fluids are used to lubricate and cool the drill bit and convey drilled cuttings or solids away from the borehole. These fluids, also called muds, are a mixture of various chemicals in a water- or oil-based solution and can be expensive to make. For environmental reasons and to reduce the cost of drilling operations, drilling fluid losses are minimized by stripping them away from the drilled cuttings before the cuttings are disposed of. This is done using various specialized machines and tanks.

Vibratory screening machines or shale shakers are the primary tools used to separate the solids from the liquids. After returning to the surface of the well, the drilling fluid flows to the shale shakers where solids are removed from the drilling fluid. Once processed by the shale shakers the drilling fluid is deposited into the mud tanks where other solid control equipment begins to remove the finer solids from it. The solids removed by the shale shaker are discharged out of the discharge port, into a separate holding tank where they await further treatment or disposal.

Screens used in the shale shakers filter the solids from the liquids. The screens are occasionally damaged by the solids being removed from the liquids, causing holes that allow unwanted solids to pass through the screens. However, it is difficult to determine if one or more screens are damaged while the shale shaker is in use.

### BRIEF DESCRIPTION OF THE DRAWINGS

Embodiments of the slurry management system are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a cross-sectional diagram of a drilling system, according to one or more embodiments;

FIG. 2 is a diagram of an RFID tag, according to one or more embodiments; and

FIG. 3 is a diagram of a slurry management system, according to one or more embodiments.

### DETAILED DESCRIPTION

The present disclosure describes a slurry management system for use with a drilling system. The slurry management system utilizes RFID tags within one or more shale shaker screens to identify locations where the shale shaker screens may have been damaged by solids in the drilling fluid flowing therethrough. The slurry management system may also notify an operator of the damage to the shale shaker screens.

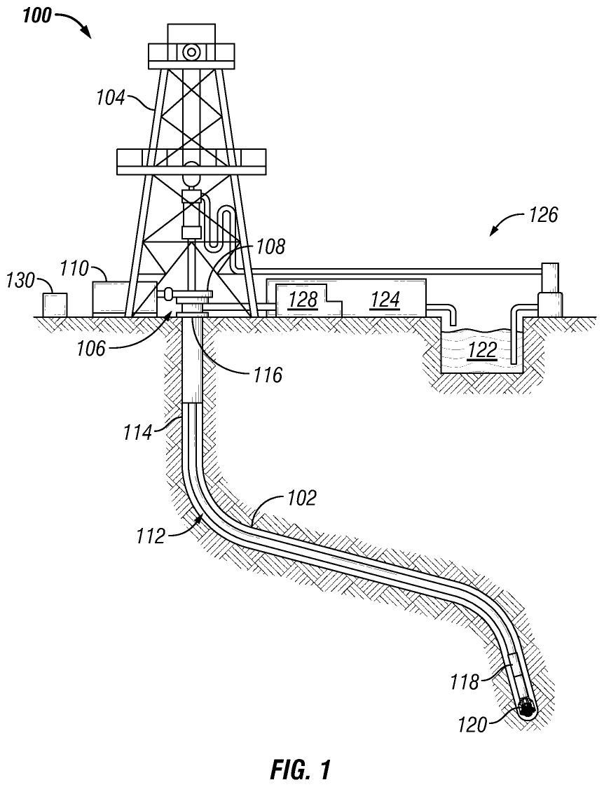

FIG. 1 is a cross-sectional view of a drilling system 100 to develop a crude oil and well-gas source. The drilling system 100 recovers oil and gas from a borehole 102 extending through various earth strata in an oil and gas formation located below the earth's surface. As shown, the drilling system 100 includes a drilling rig 104, such as the land drilling rig shown in FIG. 1. The drilling system 100 may also be deployed on offshore platforms, semi-submersibles, drillships, and the like.

As shown, a main borehole 102 may be formed in a substantially vertical orientation relative to a surface of the well. Although not show, it is known by those of ordinary skill in the art that a lateral borehole may in some instances be formed in a substantially horizontal orientation relative to the surface of the well. However, reference herein to either the main borehole or the lateral borehole is not meant to imply any particular orientation, and the orientation of each of these boreholes may include portions that are vertical, non-vertical, horizontal or non-horizontal. Further, the term “uphole” refers a direction that is towards a wellhead of a well, while the term “downhole” refers a direction that is away from the wellhead. Further, as show, the borehole 102 may not be entirely substantially vertical but in some areas may deviate at an angle from vertical and even possibly return to vertical at a later portion.

The drilling rig 104 is shown located proximate to a wellhead 106. However, the drilling rig 104 may be spaced apart from a wellhead, such as in the case of an offshore arrangement. The drilling rig 104 includes a rotary table 108, a rotary drive motor 110, and other equipment associated with rotation and translation of a drillstring 112 within the borehole 102. An annulus 114 is formed between the exterior of the drillstring 112 and the inside wall of the borehole 102. A pressure control device, such as a blowout preventer 116, and other equipment associated with drilling a borehole 102 are also provided at the wellhead 106 but are not always required.

The lower end of the drillstring 112 includes a bottom hole assembly (BHA) 118, which carries at a distal end a drill bit 120. Drilling fluid or “mud” is pumped from a fluid reservoir 122 by a mud pump 124 to the upper end of the drillstring 112 and flows through the longitudinal interior of the drillstring 112, through BHA 118, and exits from nozzles in the drill bit 120. At the downhole end of borehole 102, drilling fluid may mix with formation cuttings and other downhole fluids and debris. The drilling fluid mixture then flows upwardly through the annulus 114 to return formation cuttings and other downhole debris to the surface.

After exiting the borehole 102, the slurry flows to a slurry treatment system 126 including a shale shaker 130 in electronic communication with a control system 128, as described in more detail below. The shale shaker 130 separates the solids within the slurry from the liquid by passing the liquid through shaker screens (not shown) to filter the solids from the liquid. The liquid may be further treated and/or filtered in the slurry treatment system 126 using methods known to skilled in the art separate water, oil, and non-gas liquid hydrocarbons. The output of the slurry treatment system 126, i.e., drilling fluid, flows through piping into the fluid reservoir 122 for reuse within the borehole 102.

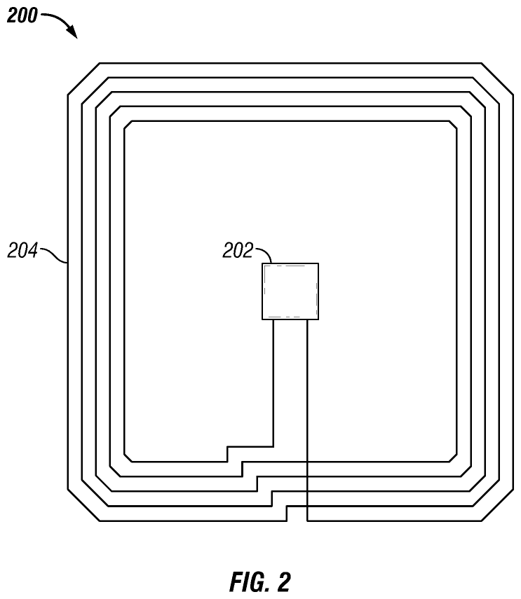

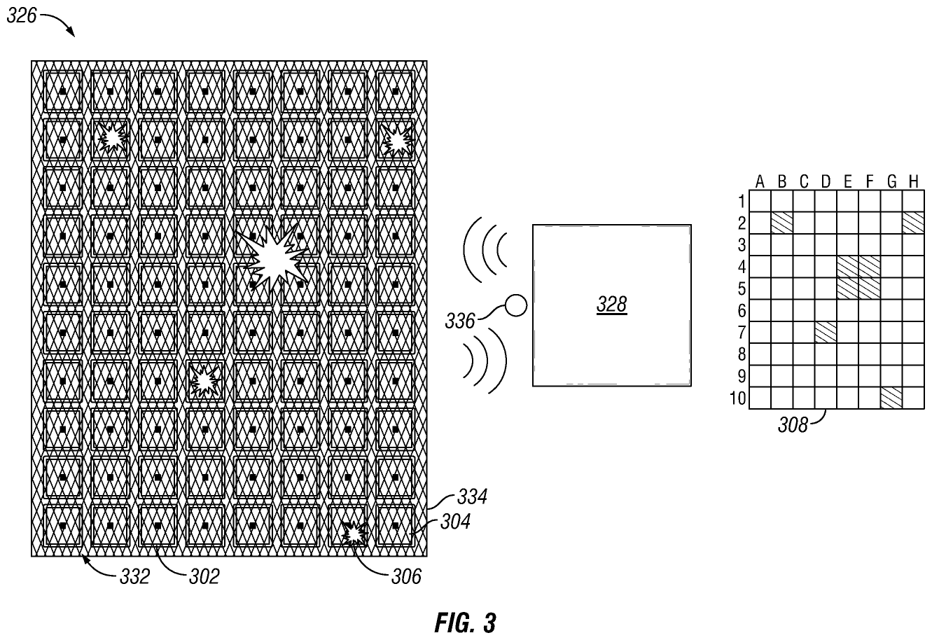

FIG. 2 is a diagram of a radio frequency identification (RFID) tag 200, according to one or more embodiments. The RFID tag 200 includes a microchip 202 with an antenna 204. The antenna 204 provides the microchip 202 with power when exposed to RF energy, such as a narrow band, high frequency EM field, from a transmitting device, such as an RFID reader 336 as described below with reference to FIG. 3. The antenna 204 may be a dipole antenna or a coil that is connected to the microchip 202 that powers the RFID tag 200 when current is induced in the antenna 204 by the RF signal.

The RFID tag 200 operates as a resonator that has a resonant frequency. The RFID reader 336 interrogates the RFID tag 200 by transmitting an RF signal that provides energy to excite the RFID tag 200. The RF signal causes the RFID tag 200 to transmit a response at the resonant frequency. The response may then be detected at the RFID reader 336 performing an RF sweep that scans one more frequency bands. If the resonant frequency of the RFID tag 200 is within the scanned frequency band(s), then the response is detected at the RFID reader. If detected, a processor in the RFID reader 336 or a control system 328, described in more detail below with reference to FIG. 3, accordingly determines that the RFID tag 200 is operational. If the RFID tag 200 is damaged, the RFID tag 200 will be unable to transmit the response to the RFID reader 336 and will thus not be detected by the RFID reader 336. If a RFID tag 200 is not detected, the processor accordingly determines that the RFID tag 200 is not operational.

FIG. 3 is a diagram of a slurry management system 300, according to one or more embodiments. The slurry management system 300 includes a shale shaker 130, as described above with reference to FIG. 1, having a shaker screen assembly 332 made up of one or more shaker screens 334, an RFID reader 336 located proximate to the shaker screen assembly 332, and a control system 328. In at least one embodiment, both the RFID reader 336 and the control system 328 are located on the shale shaker 130. In other embodiments, the control system 328 may be at a remote location, the control system 328 may be integrated with the RFID reader 336, and/or the RFID reader 336 may be mounted on a separate assembly proximate the shaker screen assembly 332. Fluid, such as drilling fluid or borehole fluid, is flowed across the shaker screen assembly 332 and the shaker screen assembly 332 filters the fluid to remove solids. The shaker screen assembly 332 also vibrates to convey the solids away from the shale shaker 130.

The shaker screen assembly 332 includes multiple RFID tags 302, such as those described above with reference to FIG. 2, arranged in an array extending across the shaker screen 334. In other embodiments, the RFID tags 302 may be arranged in a different pattern across the shaker screen or arranged randomly across the shaker screen. The RFID tags 302 may optionally be woven into a shaker screen 334. Further, the RFID tags 302 may optionally be positioned between two adjacent shaker screens 334 of the shaker screen assembly 332.

As described above, the RFID reader 336 continuously or intermittently transmits RF signals to the RFID tags 302 at various frequencies to induce a current in the antennas 304 of the RFID tags 302. The RFID tags 302 then transmit a response, which is detected by the RFID reader 336. The RFID reader 336 includes or is in communication with the control system 328. The control system 328 records the locations of the operational RFID tags 302 prior to any fluid being passed over the shaker screen assembly 332. The control system 328 may also indicate the locations of operational RFID tags 302 on a display 308 located locally at the shale shaker 130 or at a remote location. The slurry management system 300 may optionally include multiple displays 308, with any combination of local and remote displays 308.

As the solids are filtered by the shale shaker 130, some of the solids may damage the shaker screen assembly 332, creating holes 306 in the shaker screen assembly 332 that allow solids to pass through. As the RFID tags 302 are positioned on or within the shaker screen assembly 332, the RFID tags 302 are also damaged by the solids passing through the holes 306 created in the shaker screen assembly 332. However, solids that pass through undamaged shaker screen assembly 332 are normal and do not damage the RFIT tags 302.

The damage to the RFID tags 302 causes the damaged RFID tags 302 to cease responding to the RF signals transmitted by the RFID reader 336. As the RFID reader 336 transmits the RF signals, the control system 328 compares the subsequent responses from the RFID tags 302 to the responses from the RFID tags 302 prior to fluid being flowed over the shaker screen assembly 332. By comparing the responses, the control system 328 is able to determine the locations of damaged RFID tags 302 that are no longer responding and, therefore determine locations where the shaker screen assembly 332 has been damaged, allowing the control system 328 to determine the integrity of the shaker screen assembly 332.

As the RFID reader 336 transmits RF signals and receives the responses from the RFID tags 302, the control system updates the display 308 to indicate locations of damaged RFID tags 302 that are no longer responsive. This may be done through the use of different colors, different symbols, or any other way of displaying both operational RFID tags 302 and damaged RFID tags 302. The control system 328 may also notify an operator that the shaker screen assembly 332 is damaged through other means, such as an audible alarm or electronic notification. In such cases, the display 308 may be omitted or used in conjunction with the alarm and/or electronic notification.

Further examples include:

Example 1 is a slurry management system. The slurry management system includes a screen assembly and an RFID reader. The screen assembly includes a shaker screen and RFID tags arranged on the shaker screen. The RFID reader is positioned to read locations of the RFID tags.

In Example 2, the embodiments of any preceding paragraph or combination thereof further include wherein the screen assembly further includes an additional shaker screen adjacent to the shaker screen and the RFID tags are positioned between the shaker screens.

In Example 3, the embodiments of any preceding paragraph or combination thereof further include wherein the RFID tags are woven into the shaker screen.

In Example 4, the embodiments of any preceding paragraph or combination thereof further include wherein the RFID tags are arranged on the screen assembly in an array across the screen assembly.

In Example 5, the embodiments of any preceding paragraph or combination thereof further include a control system in electronic communication with the RFID reader and including a display panel configured to display read RFID tags and locations of RFID tags that are unable to be read by the RFID reader.

In Example 6, the embodiments of any preceding paragraph or combination thereof further include wherein the control system further includes a processor in electronic communication with the RFID reader and programmed to determine the locations of the read and unread RFID tags.

Example 7 is a drilling system. The drilling system includes a mud pump, a slurry management system, a drillstring, and a processor. The slurry management system includes a screen assembly and an RFID reader. The screen assembly includes a shaker screen and RFID tags arranged on the shaker screen. The RFID reader is positioned to read locations of the RFID tags. The drillstring is in fluid communication with the mud pump and the slurry management system. The processor is in electronic communication with the RFID reader and programmed to determine locations of RFID tags read by and locations of RFID tags unable to be read by the RFID reader.

In Example 8, the embodiments of any preceding paragraph or combination thereof further include wherein the shaker screen assembly further includes an additional shaker screen adjacent to the shaker screen and the RFID tags are positioned between the shaker screens.

In Example 9, the embodiments of any preceding paragraph or combination thereof further include wherein the RFID tags are woven into the shaker screen.

In Example 10, the embodiments of any preceding paragraph or combination thereof further include wherein the RFID tags are arranged on the screen assembly in an array across the screen assembly.

In Example 11, the embodiments of any preceding paragraph or combination thereof further include a display panel in electronic communication with the processor to display the locations of the read and unread RFID tags.

In Example 12, the embodiments of any preceding paragraph or combination thereof further include a control system in electronic communication with the processor and operable to notify an operator of the locations of the RFID tags that are unable to be read by the RFID reader.

In Example 13, the embodiments of any preceding paragraph or combination thereof further include a control system in electronic communication with the processor and operable to notify an operator of damage to the shaker screen assembly via an alarm.

Example 14 is a method of drilling a hydrocarbon-producing well. The method includes flowing drilling fluid through a slurry management system including a shaker screen assembly including RFID tags arranged on the shaker screen assembly and an RFID reader. The method also includes reading the RFID tags with the RFID reader. The method further includes determining an integrity of the shaker screen assembly based on the ability of the RFID reader to read the RFID tags.

In Example 15, the embodiments of any preceding paragraph or combination thereof further include wherein determining the integrity of the shaker screen assembly includes determining locations of RFID tags that are unable to be read with the RFID reader.

In Example 16, the embodiments of any preceding paragraph or combination thereof further include displaying the location of the read and unread RFID tags on a display.

In Example 17, the embodiments of any preceding paragraph or combination thereof further include notifying an operator of damage to the shaker screen assembly via an alarm.

In Example 18, the embodiments of any preceding paragraph or combination thereof further include wherein the RFID tags are arranged on the shaker screen assembly in an array across the shaker screen assembly.

In Example 19, the embodiments of any preceding paragraph or combination thereof further include wherein the shaker screen assembly further includes a first shaker screen and a second shaker screen, and the RFID tags are positioned between the first shaker screen and the second shaker screen.

In Example 20, the embodiments of any preceding paragraph or combination thereof further include wherein the RFID tags are woven into a shaker screen of the shaker screen assembly.

Certain terms are used throughout the description and claims to refer to particular features or components. As one skilled in the art will appreciate, different persons may refer to the same feature or component by different names. This document does not intend to distinguish between components or features that differ in name but not function.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A slurry management system comprising:
a screen assembly comprising a shaker screen and RFID tags arranged on the shaker screen; and
an RFID reader positioned to read locations of the RFID tags.

2. The slurry management system of claim 1, wherein the screen assembly further comprises an additional shaker screen adjacent to the shaker screen and the RFID tags are positioned between the shaker screens.

3. The slurry management system of claim 1, wherein the RFID tags are woven into the shaker screen.

4. The slurry management system of claim 1, wherein the RFID tags are arranged on the screen assembly in an array across the screen assembly.

5. The slurry management system of claim 4, further comprising a control system in electronic communication with the RFID reader and comprising a display panel configured to display read RFID tags and locations of RFID tags that are unable to be read by the RFID reader.

6. The slurry management system of claim 5, wherein the control system further comprises a processor in electronic communication with the RFID reader and programmed to determine the locations of the read and unread RFID tags.

7. A drilling system comprising:
a mud pump;
a slurry management system comprising:
a shaker screen assembly comprising a shaker screen and RFID tags arranged on the shaker screen; and
an RFID reader positioned to read the locations of the RFID tags;
a drillstring in fluid communication with the mud pump and the slurry management system; and
a processor in electronic communication with the RFID reader and programmed to determine locations of RFID tags read by and locations of RFID tags unable to be read by the RFID reader.

8. The drilling system of claim 7, wherein the shaker screen assembly further comprises an additional shaker screen adjacent to the shaker screen and the RFID tags are positioned between the shaker screens.

9. The drilling system of claim 7, wherein the RFID tags are woven into the shaker screen.

10. The drilling system of claim 7, wherein the RFID tags are arranged on the screen assembly in an array across the screen assembly.

11. The drilling system of claim 7, further comprising a display panel in electronic communication with the processor to display the locations of the read and unread RFID tags.

12. The drilling system of claim 7, further comprising a control system in electronic communication with the processor and operable to notify an operator of the locations of the RFID tags that are unable to be read by the RFID reader.

13. The drilling system of claim 7, further comprising a control system in electronic communication with the processor and operable to notify an operator of damage to the shaker screen assembly via an alarm.

14. A method of drilling a hydrocarbon-producing well, the method comprising:
flowing drilling fluid through a slurry management system comprising a shaker screen assembly comprising RFID tags arranged on the shaker screen assembly and an RFID reader;
reading the RFID tags with the RFID reader; and
determining an integrity of the shaker screen assembly based on the ability of the RFID reader to read the RFID tags.

15. The method of claim 14, wherein determining the integrity of the shaker screen assembly comprises determining locations of RFID tags that are unable to be read with the RFID reader.

16. The method of claim 15, further comprising displaying the location of the read and unread RFID tags on a display.

17. The method of claim 15, comprising notifying an operator of damage to the shaker screen assembly via an alarm.

18. The method of claim 14, wherein the RFID tags are arranged on the shaker screen assembly in an array across the shaker screen assembly.

19. The method of claim 14, wherein the shaker screen assembly further comprises a first shaker screen and a second shaker screen, and the RFID tags are positioned between the first shaker screen and the second shaker screen.

20. The method of claim 14, wherein the RFID tags are woven into a shaker screen of the shaker screen assembly.
